(19) United States
(12) Patent Application Publication
(10) Pub. No.: US 2012/0136636 A1
(43) Pub. Date: May 31, 2012

(54) FINITE ELEMENT ADJUSTMENT FOR BASIN FAULTS

(76) Inventors: ADRIAN KLEINE, AACHEN (DE); ARMIN I. KAUERAUF, AACHEN (DE); MICHAEL DE LIND VAN WIJNGAARDEN, AACHEN (DE)

(21) Appl. No.: 13/299,242

(22) Filed: Nov. 17, 2011

Related U.S. Application Data
(60) Provisional application No. 61/417,312, filed on Nov. 26, 2010.

(51) Int. Cl. G06F 17/10; G06G 7/57

(52) U.S. Cl. 703/2

(57) ABSTRACT

A method can include providing finite elements described with respect to a horizontal coordinate axis and a vertical coordinate axis to model a sedimentary basin, identifying a finite element having a horizontal boundary intersected by a fault, subdividing the finite element into two finite elements, and representing the fault along a boundary between the two finite elements. Various other apparatuses, systems, methods, etc., are also disclosed.

### RELATED APPLICATION

This application claims the benefit of U.S. Provisional Patent Application Ser. No. 61/417,312, filed on Nov. 26, 2010, which is incorporated by reference herein.

### BACKGROUND

Sedimentary basins can be modeled using numerical techniques such as the finite element method. Such basins can include one or more faults. Various issues arise when modeling basin faults. For example, finite elements may not be properly oriented with respect to a fault. Where petroleum systems modeling is desired, for example, to model migration of fluid near or at a fault, improper orientation of finite elements can give rise to inaccuracies. Various technologies, techniques, etc., described herein can provide for finite element adjustment for basin faults.

### SUMMARY

A method can include adjusting finite elements of a basin model to account for one or more faults. Such a method can include identifying particular finite elements with respect to a fault and adjusting an identified finite element by, for example, moving one or more of its nodes, subdividing the finite element, moving one or more of its nodes and subdividing the finite element or subdividing the finite element and moving one or more shared nodes of the resulting finite elements. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of petroleum systems modeling;

FIG. 3 illustrates examples of equations that may be used in petroleum systems modeling;

FIG. 4 illustrates an example of evolution of a basin with respect to time;

FIG. 5 illustrates an example of finite elements for modeling a basin along with some examples of fluid migration;

FIG. 6 illustrates an example of a method for subdividing a finite element;

FIG. 7 illustrates an example of a method for adjusting finite elements;

FIG. 8 illustrates an example of a method for adjusting finite elements;

FIG. 9 illustrates example scenarios for faults with respect to finite elements;

FIG. 10 illustrates an example of a method for adjusting finite elements and optionally deciding whether to shift a node or nodes;

FIG. 11 illustrates an example of a method for adjusting finite elements; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

In basin and petroleum systems modeling quantities such as pore pressure and temperature distributions within the sediments may be modeled by solving partial differential equations (PDEs) using a finite element method. In an example embodiment, a method can generate a grid for finite elements (e.g., finite element nodes) with alignment to a fault to refine a local grid in the vicinity of the fault. Such a method may be automated to occur during a particular point within a modeling process and such a method may occur one or more times, for example, where a model is updated or revised in an iterative manner.

Basin and petroleum systems modeling may assess generation, migration and accumulation of hydrocarbons. Quantities such as pore pressure, geomechanical stresses and strains, temperature, and fluid potentials can assist understanding of a sedimentary basin and provide for an estimation of hydrocarbon generation, migration, and accumulation. These quantities may be described via formulations of equations that include PDEs. A spatial distribution and evolution through geological time of such processes may be a goal of basin modeling.

As analytical solutions seldom exist for PDEs, numerical simulation may be employed using a computing device, a computing system, etc. Various numerical techniques may include discretization of a space to form a model. For example, a finite element model may include many finite elements (e.g., a few million elements) where each element has an associated set of properties, for example, lithology (e.g., type of the material), porosity, temperatures, pore pressure, etc. Alignment of a grid for finite elements with geological features such as layer horizons and faults can help to provide an accurate and efficient simulation.

In an example embodiment, a method can create a grid that is suitably aligned with one or more geological features while allowing an efficient implementation and simulation on a computing device or computing system. Such a method can include providing a basic grid construction so that it is suitably aligned with global features of a model (e.g., layer horizons for a basin) followed by improving the description of local features (e.g., faults) by locally altering the grid by splitting an existing finite element into two (or possibly more) smaller finite elements and by shifting the position of one or more nodes of the smaller finite elements. In such a manner, an improved grid and finite elements can be generated.

In a modeling process for a basin, layer horizons may be considered to construct a grid for finite elements. After consideration of the layer horizons, faults may be projected on surfaces (e.g., boundaries) between two adjacent finite elements. Such a process can result in fault geometries that may possess a zigzag shape, which may limit their use for purposes of performing simulations. To improve the grid, finite elements that are crossed by the fault (e.g., in a “diagonal manner”) can be split into two (or more) smaller finite elements. After splitting, the faults can be re-projected or adjusted onto surfaces (e.g., boundaries) between adjacent finite elements. In such an example, where finite elements have been locally refined, representation of a fault tends to be more accurate.

Additionally, or alternatively, node movement may occur. For example, local movement of one or more nodes may occur to improve representation of a fault. Such movement may be conditioned to ensure that shifting of a node does not misalign geometry of a horizon. Further, a condition may be imposed such that a shift may be restricted to be smaller than the size of a finite element, for example, to avoid global topology changes to a grid by movement of a node or nodes.

The finite element method can include mapping (e.g., spatial transformations), for example, where a finite element is mapped from a physical space to a unit space to facilitate integration. Such an approach allows for various finite element shapes in the physical space (or physical domain being modeled). In contrast, other techniques for spatial modeling such as finite difference or finite volume methods can exhibit numerical problems when considering deformed grids. In certain cases, these numerical problems may be severe. While mapping or transforms may be applied to these other techniques, they might not be inherent to these other techniques and may act to increase computational demands.

In an example embodiment, a method to more accurately represent a fault in a finite element model can be incorporated into an existing simulator program. In such an example, basic topology as well as the general geometry of a grid may be preserved, which may allow for usage of many types of analysis techniques in addition to finite element analysis.

For a finite element, material properties (e.g., rock or other material) may be uniformly defined. A grid for the finite elements (e.g., to define node positions for finite elements) can be aligned to geological features to describe geological volumes. A model may represent geological volumes in one or more dimensions in space (e.g., 1D, 2D, or 3D). For example, for a 2D model, two-dimensional finite elements may represent volumes that interact with neighboring two-dimensional finite elements (e.g., for rectangular elements, an interior element may have four neighbors with shared boundaries and four additional neighbors with a shared node). For a 3D model, an interior cuboid element can have six neighbors with shared surfaces and up to an additional twenty four neighbors with a shared node (e.g., eight nodes with three additional neighbors per node, noting that the number can differ for collapsed surfaces, etc.). While boundary conditions may be limited to the six shared surfaces, where a node is shifted, the finite elements that share the shifted node will be affected. In an example embodiment, a method can operate on a 2D spatial finite element model or a 3D spatial finite element model. Further, an additional temporal dimension may make such models 3D and 4D overall.

Various issues exist for modeling and simulation of hydrocarbon generation amounts and trap sizes with captured hydrocarbons. In particular, model accuracy with respect to physical geometry of a geologic formation can impact accuracy as hydrocarbon migration pathways often follow small scale structures. Where mismatches exist between physical geometry and model geometry, inaccuracies related to migration may result. Such inaccuracies can impact exploration and appraisal of a basin and resources therein, for example, as to pressure prediction and well placement.

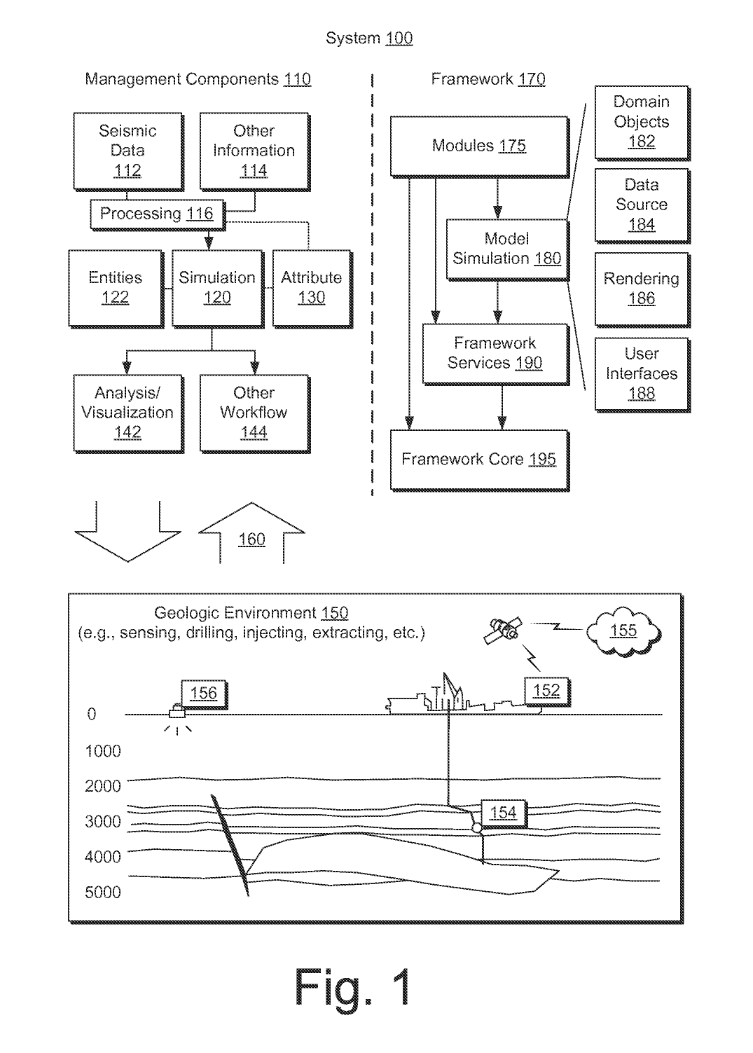

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

In an example embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists and reservoir engineers) can develop collaborative workflows and integrate operations to streamline processes. Such a framework may be considered an application and may be considered a data-driven application (e.g., where data is input for purposes of simulating a geologic environment).

In an example embodiment, the management components 110 may include or interact with features of a commercially available simulation framework such as the PETROMOD® petroleum systems modeling software framework (Schlumberger Limited, Houston, Tex.). The PETROMOD® framework includes 1D, 2D, and 3D packages as well as add-ons and PETREL® framework plug-ins. A particular plug-in allows PETREL® to import data from the PETROMOD® framework. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc.

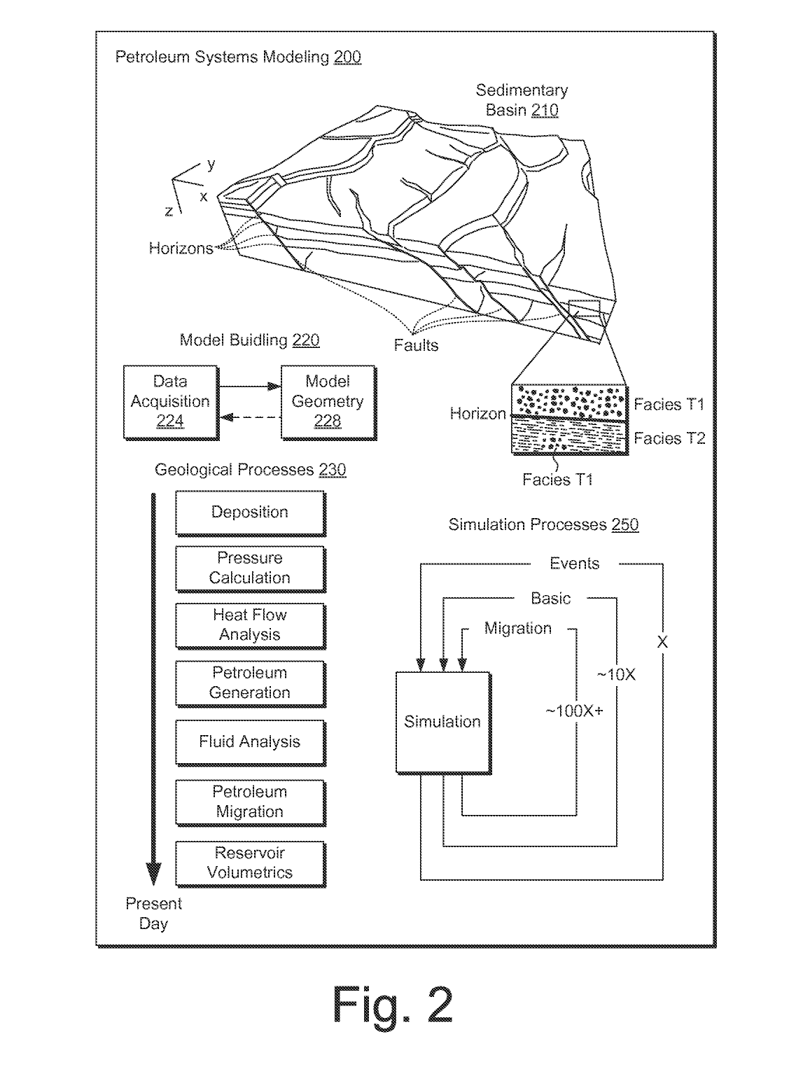

FIG. 2 shows various aspects of an example of petroleum systems modeling 200, including a sedimentary basin 210, model building 220, geological processes 230 and simulation processes 250. In general, petroleum systems modeling may be applied to various types of subsurface environments, including environments such as the underwater geologic environment 150 of FIG. 1.

In FIG. 2, the sedimentary basin 210 includes horizons, faults and facies formed over some period of geologic time. These features are distributed in two or three dimensions in space, for example, with respect to a Cartesian coordinate system (e.g., x, y and z) or other coordinate system (e.g., cylindrical, spherical, etc.). The model building 220 includes a data acquisition block 224 and a model geometry block 228. Some data may be involved in building an initial model and, thereafter, the model may optionally be updated in response to model output, changes in time, physical phenomena, additional data, etc. Data may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of the geological processes 230, data is provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

The geological processes 230 may be part of a forward modeling process that performs calculations to simulate phenomena such as sediment burial, pressure and temperature changes, kerogen maturation and hydrocarbon expulsion, migration and accumulation. For example, a deposition block may account for sedimentation, erosion, salt doming, geologic event assignment; a pressure calculation block may account for pressure calculation and compaction; a heat flow analysis block may account for kinetics of thermal calibration parameters and calculate temperatures; a petroleum generation block may account for generation, adsorption and expulsion; a fluid analysis block may account for phase and compositions of fluid(s); a petroleum migration block may account for Darcy flow, diffusion, invasion percolation, and flowpath analysis; and a reservoir volumetrics block may account for column height of an accumulation, capillary entry pressure of a seal, leakage, break through, secondary cracking, and biodegradation.

With respect to simulation processes 250, one or more loops may be implemented, for example, according to time scales for various phenomena. In the example of FIG. 2, three loops are shown: Events, Basic and Migration. An events loop may characterize a geological period in which one layer has been uniformly deposited or eroded or when a geological hiatus occurred. A total number of events (e.g., iterations of the loop) may be on the order of the number of geological layers (e.g., between 20 and 50). With respect to a basic loop, events may be subdivided into basic time steps with a solution for pressure or compaction and heat equations. The length of a basic time step can depend on deposition or erosion amounts and on a total duration of an event. A total number of basic time steps may be between approximately 200 and 500. As to a migration loop, these may stem from further division of basic loop time steps. For example, migration steps may provide for a Darcy flow analysis where transported fluid amount for an element of a model may be restricted to a pore area or volume of that element (e.g., depending on dimensionality of the model element). A total number of steps for migration may be approximately 1,000 up to 50,000 or more, which may depend on flow activity, rock permeability, selected migration modeling technique, etc. In the example of FIG. 2, the loops are shown with some examples of scaling from X for the events loop, approximately 10× for the basic loop and approximately 100× or more for the migration loop.

As to transport processes (e.g., heat flow, pore pressure and compaction, Darcy flow migration processes and diffusion), a model can aim to account for a flow variable acting from a first location onto another location. For example, given temperature as a state variable and heat flow as a corresponding flow variable, a difference in temperature with respect to space (e.g., a temperature gradient) causes heat flow, which generally acts to decrease a temperature difference (e.g., drive toward an equilibrium temperature). As mentioned, boundary conditions may be provided to formulate a boundary value problem guided by an energy or mass balance to provide state and flow variable values with respect to time.

A formulated boundary value problem may be solved for state and flow variable values with respect to time using one or more numerical techniques. For example, the finite element method may include defining finite elements that fill a geological space (e.g., in 1D, 2D or 3D) where time steps occur using a finite difference technique. In such an example, at each time step, a finite element model may be solved (e.g., in a linear or non-linear manner) and, once solved, a finite difference technique may act to “perturb” or “estimate” state values for a forward time (e.g., which may be in the future or past) or reverse time (backward time, e.g., which may be in the future or past), where these values are used as an initial guess to solve the finite element model at the iterated time (e.g., finite element method for spatial modeling and finite difference for temporal modeling).

In an example embodiment, neighboring finite elements may be linked at a shared boundary (e.g., a point, a line or a surface) where the boundary conditions for two or more neighboring finite elements may be matched (e.g., energy-wise, material-wise, etc.). As an example, consider a mass of fluid exiting one finite element and entering a neighboring finite element (e.g., adjacent finite element). Where the porosity of the two finite elements differs, fluid velocity may differ for each finite element while mass and momentum are conserved across their shared boundary. Similar types of examples exist for other phenomena such as temperature and heat energy.

With respect to solving a finite element model using the finite element method (e.g., or finite element analysis), inversion of a matrix can provide for a solution vector (e.g., for state variables of various finite elements). As an example, a finite element model may include many finite elements (e.g., thousands) with many unknowns (e.g., thousands). Larger finite element models can include more than a million finite elements with over a million unknowns. Solution time or resources requirements may depend on the number of unknowns, number of linked equations, linearity or nonlinearity of a formulation of equations, property dependence on one or more state variables, etc. Solution time or resource requirements may be determined on the basis of a relationship between matrix inversion and number of unknowns as well as knowledge of other factors such as matrix diagonality. In general, solution time or resource requirements may scale nonlinearly (e.g., exponentially) with respect to number of finite elements (e.g., number of unknowns). As an example, doubling the number of finite elements along one dimension can increase computing effort by an order of magnitude. Accordingly, some trade-offs may exist as to solution accuracy (e.g., more finite elements) and solution timing (e.g., for fixed computing resources) or solution requirements (e.g., ability to increase number of cores, memory, etc.).

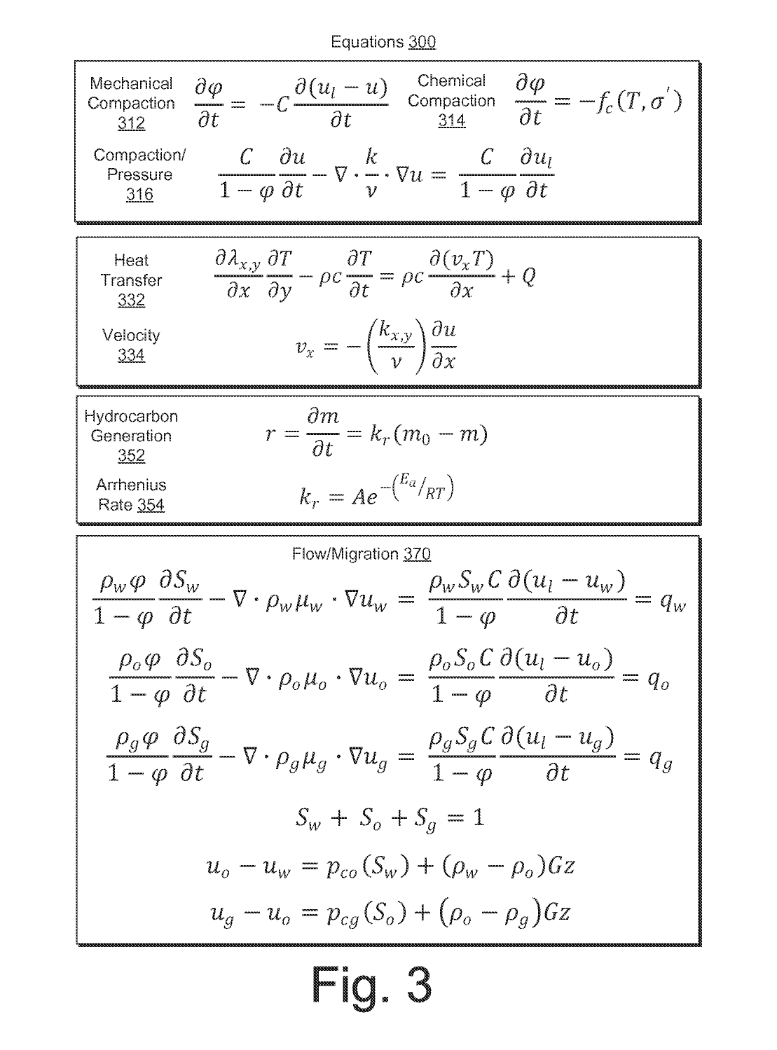

FIG. 3 shows examples of equations 300 for modeling petroleum systems. Equations 312, 314 and 316 represent compaction and pressure phenomena, equations 332 and 334 represent heat transfer, equations 352 and 354 represent hydrocarbon generation and equations 370 represent flow/migration of multiple components and multiple phases (e.g., water, oil and gas). As indicated, petroleum systems modeling can include variables (e.g., material properties) such as porosity (φ) and compressibility of material (e.g., rock) (C), hydraulic potential of effective stress (u) (e.g., consider stress tensor σ, external load τ, and fluid pressure, (p), thermal conductivity tensor (λ_{i,j}), density (ρ), heat capacity (c), fluid velocity tensor (vᵢ), permeability tensor (k_{i,j}), viscosity (ν), mobility (μ), Arrhenius rate constants (kᵣ), temperature (T), saturation (S), capillary pressure (p_{c}), and volumetric flow (q). As indicated in FIG. 3, chemical compaction induced porosity loss as a function of temperature and effective stress may be included in an analysis (e.g., per the equation 314). Other variables may include one or more diffusion coefficients (D_{c}) where a diffusion flux occurs in response to a concentration gradient of a component or components (cᵢ). Nonlinearities may be inherent in one or more equations or stem from dependencies (e.g., consider Arrhenius rate constant with respect to temperature, convection, etc.). Accounting for nonlinearities may increase solution effort, however, they may also increase resource requirements.

As indicated, one or more variables may be anisotropic. For example, a tensor variable may differ depending on direction. Orientation of material with respect to gravity may also be a factor, for example, a material type (e.g., facies) may be compactable in a particular direction when acted upon by a load due to gravity. In such an example, permeability of the material may likewise be impacted due to its orientation with respect to gravity. As shown in the flow/migration equations 370, gravity (G) may be included in an equation for pressure or buoyancy (e.g., water flow may depend on a difference between a pressure and a head pressure determined on the basis of a water density (ρ_{w}), gravity (G) and depth (z)).

The equations 300 of FIG. 3 are provided as examples to explain some variables and partial differentials that may be used to represent various phenomena. While the equations may reference some dimensions (e.g., x, y, z), equations may be formulated in one, two or three dimensions in space, where time may be viewed as an additional dimension (e.g., 3D in space and 1D in time to provide a 4D formulation). The equations 332, 334, 352 and 354 also illustrate how transport of heat energy can impact hydrocarbon generation, for example, by increasing or decreasing temperature and thereby altering the Arrhenius rate constant for rate of formation of a hydrocarbon with respect to time. The heat transfer equation 332 also includes a source term (Q), which may account for radioactive processes or other heat source/sink processes.

Given equations such as those of FIG. 3, petroleum expulsion and migration may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient (see, e.g., the equations 370).

The finite element method is suitable for modeling phenomena that can be formulated via partial differential equations as well as other types of equations. The aforementioned PETROMOD® framework includes features for finite element models to be solved using the finite element method, optionally with time discretization achieved via a finite difference approach.

In an example finite element model, each finite element includes properties to match the finite element to some physical space (e.g., line, surface or volume, noting that dimensional reductions may be applied via symmetry or other bases). As an example, consider a finite element that include facies-related properties for a particular location as well as information (e.g., coordinates, index, indexes, etc.) to define its location. Given a location and facies related properties, for example, compaction and pressure determinations may be made for the finite element using the finite element method.

In an example geologic layer disposed between or defined by an upper horizon and a lower horizon, adjacent finite elements may differ, for example, based on their respective facies. Where a fault exists in a layer, the fault may mark a discontinuity between facies (e.g., rock facies, organic facies, etc.). For example, on one side of the fault, a finite element may be assigned facies set A while on the other side of the fault, an adjacent, neighboring finite element may be assigned facies set B, hence, a discontinuity exists in properties of the neighboring finite elements (e.g., which may affect flow, etc., at or across a fault).

According to an example embodiment, locating a fault directly at the boundaries between two adjacent finite elements represents an optimal scenario. In practice, however, a fault may run directly through a finite element and may be discretely represented as a zigzag, for example, due to computational and other costs increasing with an increasing number of finite elements, which could allow for finer discretization. In certain embodiments, finer modeling of a fault by merely increasing finite element number (e.g., by decreasing finite element size) at the fault can come with certain costs. Accordingly, an example approach may aim to increase model accuracy without overly increasing computational demands.

In general, a relationship exists between size of a finite element and the phenomenon or phenomena being modeled. Various scales may exist within a geologic environment, for example, a molecular scale may be on the order of 10⁻⁹ to 10⁻⁸ meters, a pore scale may be on the order of 10⁻⁶ to 10⁻³ meters, bulk continuum may be on the order of 10⁻³ to 10⁻² meters, and a basin scale on the order of 10³ to 10⁵ meters. Given such scales, a finite element model may include finite elements having sizes on the order of 1 to 10² meters (e.g., smaller than a basin scale and larger than a pore scale). In a finite element model, a continuous crossover within a finite element can, for example, dictate a comparison between a bulk continuum scale and a basin scale rather than the finite element size and the basin scale as for some other types of numerical discretization techniques. Implicitly, finite elements can provide for higher resolution than some other types of numerical discretization techniques given the same “discretization” dimension (e.g., comparing a finite element to a “cell” of another technique). A finite element model may include multiple finite element sizes, optionally where a size corresponds to a phenomenon or phenomena to be modeled. As an example, heat flow may be modeled using finite elements having sizes less than 100 meters whereas finite elements to model migration of hydrocarbons may be smaller.

As mentioned, the number of finite elements can determine the number of unknowns and solution time or resource requirements. A finite element model of a basin may span, for example, hundreds of kilometers or a few kilometers. Model resolution may aim to approximate geological structures of interest while allowing for suitable simulation run times on available computing resources. A finite element model may include over a million finite elements, for example, with several thousand finite elements along a horizontal dimension. For example, a two-dimensional finite element model may include about 3,000 finite elements along a horizontal dimension and about 300 finite elements along a vertical dimension.

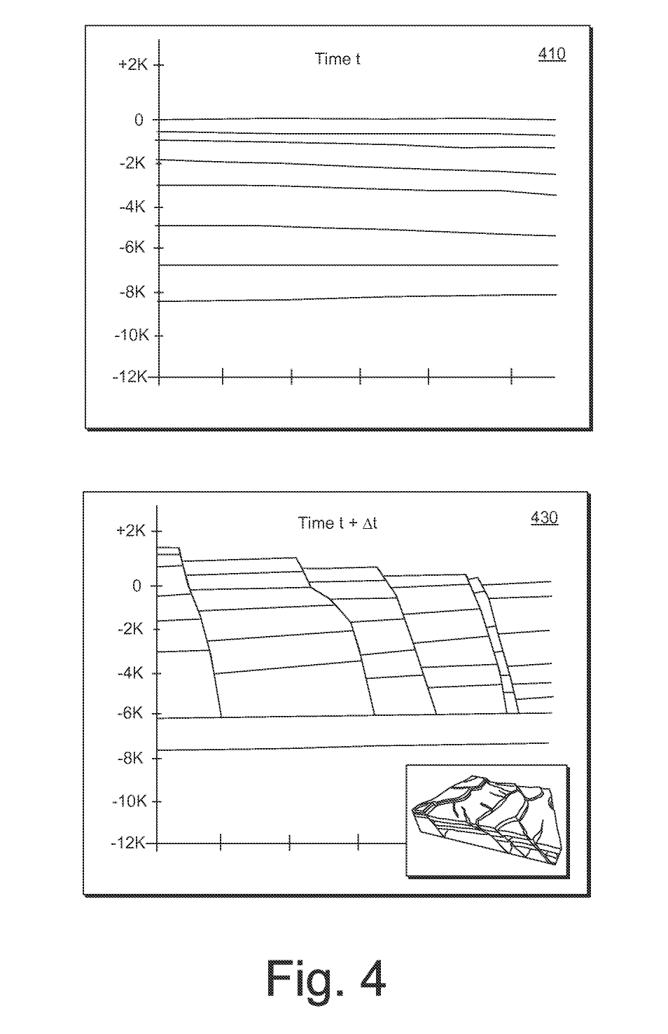

FIG. 4 shows an example of a basin in two dimensions for a time t, plot 410 and for a time t plus Δt, plot 430, where Δt is millions of years. A small graphic in the plot 430 shows a perspective view of a sedimentary basin for which the plot 430 represents a two-dimensional section thereof. A finite element model may model such a basin and allow for simulations to demonstrate evolution of the basin, forward or backward in time (e.g., using time steps of size or sizes that may account for dynamics of one or more phenomena, etc.). Calibrations may be performed to refine the model, for example, by comparing simulation results with measurements from the basin being modeled. Such calibrations may act to update timing of deposition, erosion, hiatus, tectonic events, compaction, etc., for example, for purposes of re-running one or more simulation processes (see, e.g., the model building 220, the geological processes 230 and simulation processes 250 of FIG. 2).

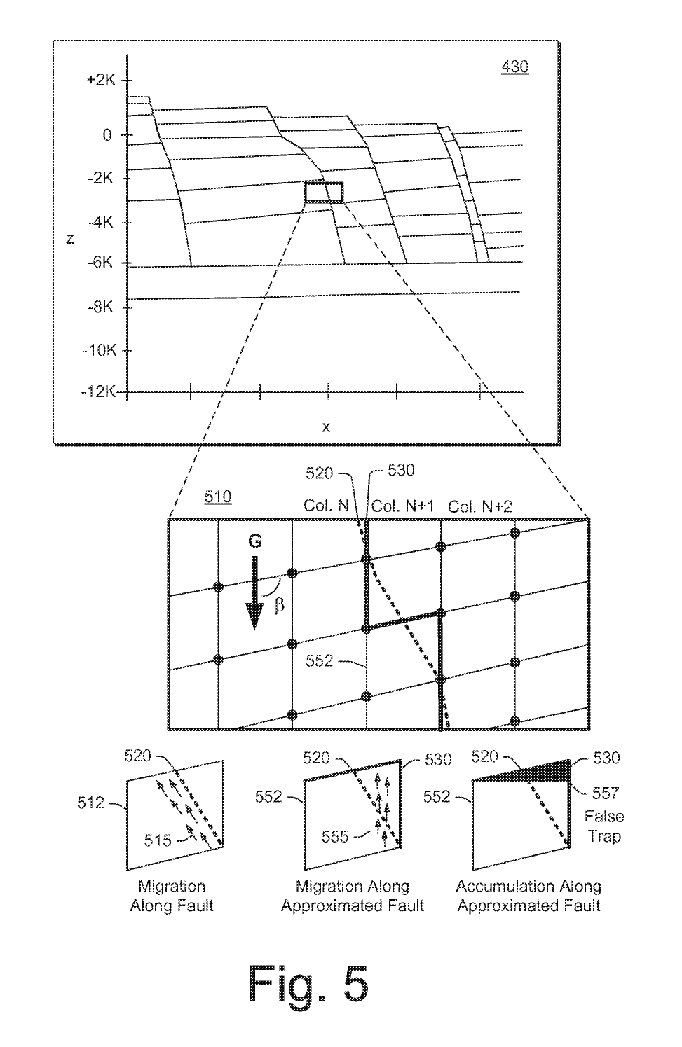

FIG. 5 shows the plot 430 along with finite elements 510 for a portion of the basin within a layer disposed between two horizons and including a fault 520. The finite elements 510 are also shown with respect to gravity and an angle β at which top and bottom boundaries of the finite elements are disposed with respect to a horizontal direction. The angle β may be determined by any of a variety of factors (e.g., horizon angle, dip angle, facies, etc.).

In petroleum systems modeling, finite elements may be stacked vertically such that finite element columns exist, optionally according to a surface map (see, e.g., Col. N, Col. N+1, and Col. N+2). In the example of FIG. 5, a model fault line 530 models the fault 520 by following the boundaries between adjacent finite elements (e.g., between finite element columns N and N+1 and then N+1 and N+2). A decision making process may act to place the model fault line 530. For example, a line may be drawn along a fault between two points that span multiple finite elements and thereafter a zigzag boundary (e.g., stepped boundary) drawn such that the boundary starts at the first point and ends at the second point, for example, where horizontal moves (e.g., that follow a “horizontal” boundary or boundaries) are limited to a few number of finite elements (e.g., one, two or three).

FIG. 5 also illustrates some consequences that may result from the zigzag or stepped model fault line 530. A finite element 512 shows migration 515 along the fault 520. For example, pressure or buoyancy may direct fluid upward along a fault where the fault acts as a boundary (e.g., discontinuity in one or more material properties). A finite element 552 shows migration 555 along a model fault line 530 where the migration 555 passes through the actual fault 520. At a later time step, due to the configuration of the model fault line 530, a false trap 557 may trap fluid that has migrated. In this example, the false trap 557 is erroneous as the actual fault 520, as running through a space corresponding to the finite element 552, would not form such a trap. In the example of FIG. 5, the diagram visually depicts the “false trap;” noting that the finite element 552 would mathematically account for the accumulation (e.g., due to the geophysical location of its nodes and boundaries) and that any inaccuracies would impact one or more neighboring finite elements. In essence, the “false trap” would impact not just a “corner” of the finite element 552 but the entire finite element 552. As equations associated with the finite element 552 form part of a larger system of equations, the solution to the larger system of equations would be affected by the “false trap.” Where many false traps exist due to, for example, a column-to-column zigzag, these false traps would have an overall impact on the accuracy of any solution of the larger system of equations (e.g., as to migration near a fault). While the example of FIG. 5 pertains to migration, other phenomena may be affected alternatively or additionally (e.g., anisotropic heat transfer, etc.).

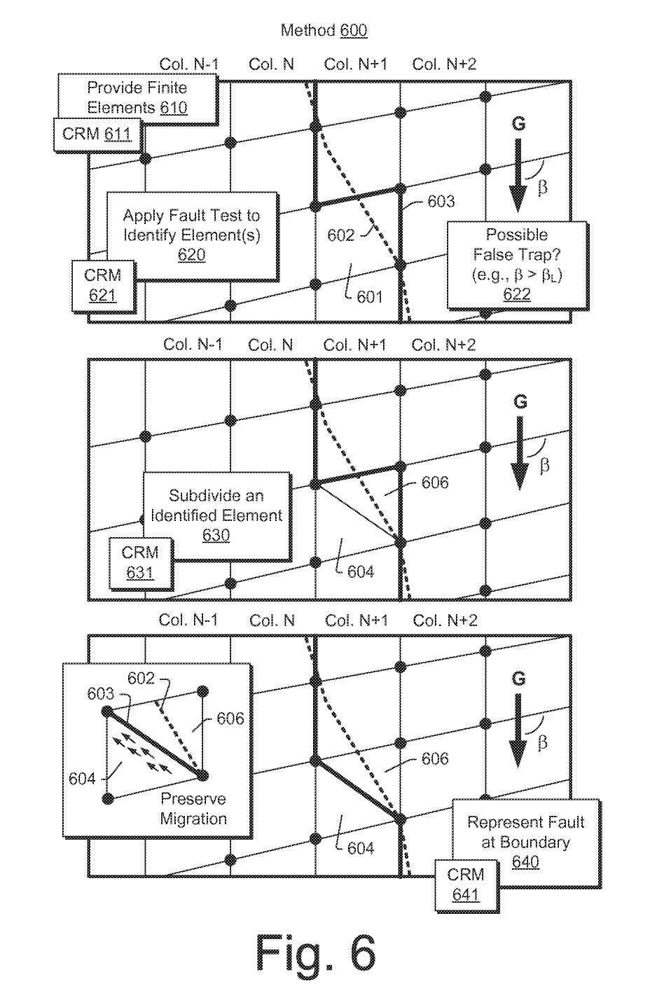

FIG. 6 shows an example of a method 600 that can subdivide one or more finite elements. As shown, in a provision block 610, finite elements are provided, which may be arranged (e.g. vertically in columns (e.g., N−1, N, N+1, N+2, etc.)), where a fault 602 is represented by an approximate fault line 603. In an application block 620, a fault test is applied to identify one or more finite elements as candidates for subdivision. For example, per a block 622, a test may determine whether a false trap may be possible where an approximated fault line transitions between finite element column boundaries (e.g., consider the transition of the approximate fault line from the N/N+1 boundary to the N+1/N+2 boundary). Such a test may optionally determine whether a horizontal boundary angle (e.g., β) exceeds a boundary angle limit (e.g., β_{L}). As illustrated in the example of FIG. 5, as a boundary angle increases with respect to gravity, a false trap may trap more fluid. While a false trap is mentioned, one or more other phenomena may form a basis for a test (e.g., of the application block 620).

Per the application block 620, the finite element 601 may be identified. Once identified, a subdivide block 630 subdivides the finite element 601 into finite elements 604 and 606. In the two-dimensional example of FIG. 6, the quadrilateral finite element 601 becomes two triangular finite elements 604 and 606. In a three-dimensional example, a cuboid finite element (e.g., a hexahedron) may be subdivided to become two finite elements, for example, two triangular prism finite elements (e.g., where a triangular prism is a pentahedron composed of two triangular bases and three rectangular sides). Thus, in a three-dimensional example, a finite element may be split into two finite elements where the resulting finite elements have fewer sides than the original finite element (e.g., hexahedron to pentahedron) and fewer nodes than the original finite element (e.g., eight nodes to six nodes). In a three-dimensional example, the fault may be represented as a shared side of two finite elements (e.g., a two-dimensional surface).

In the example of FIG. 6, after subdivision of the finite element 601, per a representation block 640, the resulting two finite elements 604 and 606 share two common nodes and a common boundary, which becomes a portion of the approximate fault line 603 that more accurately represents the fault line 602. While the approximate fault line 603 may still differ from the fault line 602, the angle of the approximate fault line 603 can avoid a false trap and preserve migration of fluid, for example, as influenced by buoyancy, fault characteristics, etc.

The method 600 is shown in FIG. 6 in association with various computer-readable media (CRM) blocks 611, 621, 631 and 641. Such blocks generally include instructions suitable for execution by one or more processors (or cores) to instruct a computing device or system to perform one or more actions. While various blocks are shown, a single medium may be configured with instructions to allow for, at least in part, performance of various actions of the method 600.

In an example embodiment, a method can include providing finite elements described with respect to a horizontal coordinate axis and a vertical coordinate axis to model a sedimentary basin; identifying a finite element having a horizontal boundary intersected by a fault; subdividing the finite element into two finite elements; and representing the fault along a boundary between the two finite elements. In such an example, identifying can include identifying a horizontal coordinate axis intersection point of the fault with respect to the horizontal boundary of the finite element where the method may further include shifting a shared node of the two finite elements to the intersection point. Where a sedimentary basin includes multiple faults, a method can include repeating various actions for one or more of the multiple faults.

In the example of FIG. 6, the method 600 can further include simulating physical phenomena in the sedimentary basin with respect to time, simulating migration of fluid in the sedimentary basin (e.g., simulating migration of fluid adjacent to the fault), modeling evolution of the sedimentary basin using the finite elements with a finite element technique for spatial modeling and a finite difference discretization of time with a finite difference technique for temporal modeling, etc. In the example of FIG. 6, the finite elements may be two-dimensional or three-dimensional finite elements and the finite elements may have associated properties where, for example, property values may be based at least in part on measured values.

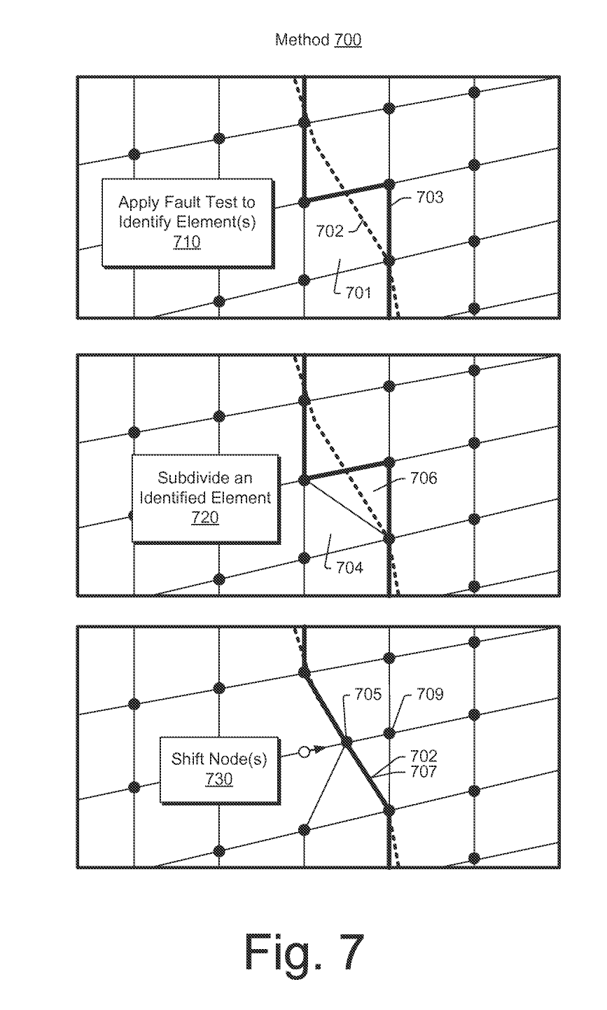

FIG. 7 shows an example of a method 700 that can adjust finite elements to more accurately generate a model fault line. The method 700 commences in a test application block 710 that applies a fault test to identify one or more finite elements that give rise to a step, which may include an inclined step (e.g., inclined upward with respect to gravity). A test may determine if an actual fault (e.g., a fault based on at least some measured data) passes through a boundary of an element. For example, for an element 701, a fault 702 passes through a top boundary. Without any adjustment, an algorithm may simply define a model fault line 703 as existing along the top boundary. As the top boundary of the element 701 is inclined, such an approach could result in one or more simulation errors (e.g., false trap or other inaccuracy).

According to the method 700, once an element has been identified, a subdivide block 720 acts to subdivide the identified element. In the example of FIG. 7, the element 701 is subdivided into element 704 and element 706, which share a common boundary. After subdivision, a shift block 730 acts to shift one or more nodes of the elements 704 and 706 toward the fault 702. In the example of FIG. 7, by shifting the node 705, an adjusted model fault line 707 more accurately represents the fault 702. Note that movement of the node 709 could also occur as an alternative. Yet further, as another alternative, movement of the node 705 and the node 709 toward each other to the fault 702 may occur, which would reshape the finite element 704 while collapsing the finite element 706. As to this latter alternative, a method can include shifting of nodes without subdividing an element (e.g., block 710 followed by block 730).

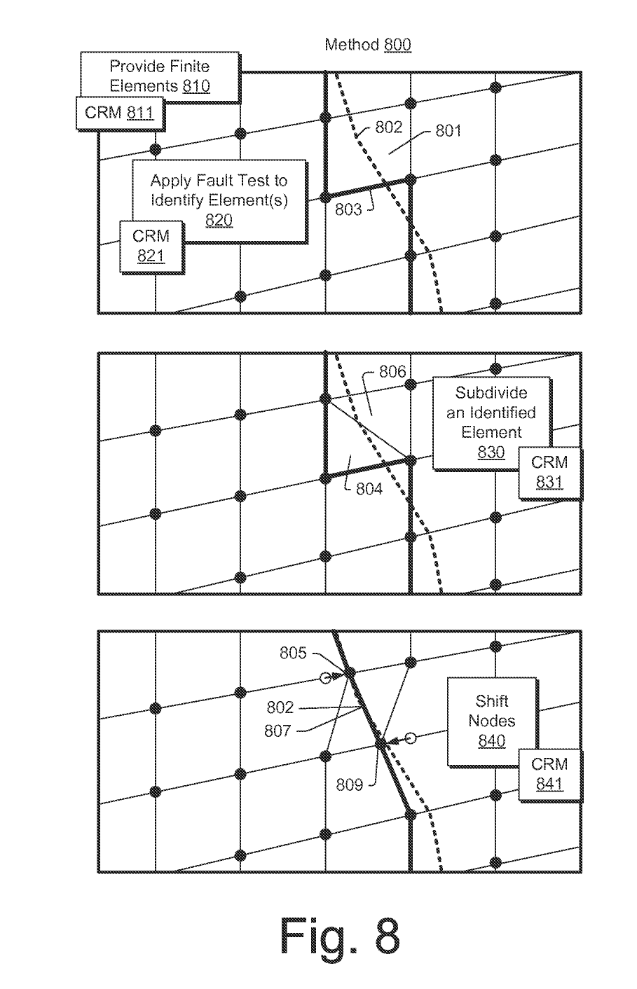

FIG. 8 shows an example of a method 800 that can adjust finite elements to more accurately generate a model fault line. The method 800 includes a provision block 810 to provide finite elements and a test application block 820 that applies a fault test to identify one or more finite elements that give rise to a step, which may include an inclined step (e.g., inclined upward with respect to gravity).

According to the method 800, once an element has been identified, a subdivide block 830 acts to subdivide the identified element. In the example of FIG. 8, the element 801 is subdivided into element 804 and element 806, which share a common boundary. After subdivision, a shift block 840 acts to shift a node of the element 804 and a node of the element 806 toward the fault 802. In the example of FIG. 8, by shifting the nodes 805 and 809, an adjusted model fault line 807 more accurately represents the fault 802. In the example of FIG. 8, the nodes 805 and 809 are shifted in opposing directions (e.g., opposite directions where one moves along an incline and the other moves along a decline).

The method 800 is shown in FIG. 8 in association with various computer-readable media (CRM) blocks 811, 821, 831 and 841. Such blocks generally include instructions suitable for execution by one or more processors (or cores) to instruct a computing device or system to perform one or more actions. While various blocks are shown, a single medium may be configured with instructions to allow for, at least in part, performance of various actions of the method 800.

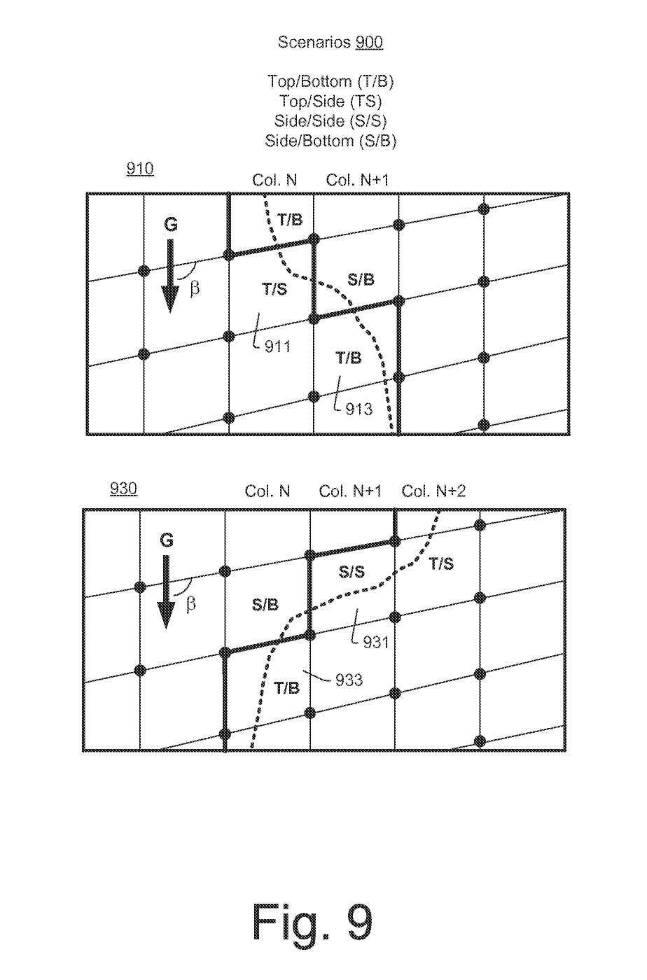

FIG. 9 shows some examples of fault and model fault line scenarios 900. These scenarios include top/bottom, top/side, side/side and side/bottom traversals of a fault with respect to a finite element. In practice, top/side and side/bottom configurations can be observed in basin modeling (e.g., as a lateral extension of a fault can exceed one element because a fault may include deviations from vertical).

Side/side configurations tend to be less common, however, these may occur when modeling listric faults. In an example embodiment, modeling of a listric fault (e.g., where the fault passes through opposing vertical boundaries (e.g., sides) of a finite element), may include shifting nodes of a top or a bottom boundary of the element vertically (e.g., both up or both down). As an alternative, such modeling may project the model fault line upward or downward without moving any nodes. Determinations as to moving nodes or projecting a model fault line upward or downward may depend on a horizon or facies analysis. For example, if the moving or projecting acts to alter facies of an element, that moving or projecting may be prohibited or redirected (or chosen) to preserve the facies of the element.

In a scenario 910, a fault passes from an upper left to lower right direction through various finite elements. In the scenario 910, finite elements 911 and 913 may be identified, subdivided and one or more nodes of each finite element moved.

In a scenario 930, a fault passes from an upper right to lower left direction through various finite elements. In the scenario 930, the false trap type of inaccuracy may not occur, however, inaccuracies may still arise where a model fault line has a slope that deviates from that of the fault. In the scenario 930, finite elements 931 and 933 may be identified. For the element 931, nodes of the lower boundary may be raised vertically to meet the fault. Such action has consequences for the element 933, as its upper right node is shared (in common) with the element 931. However, the element 933 may still be subdivided and, for example, its lower left node may be moved toward the right to meet the fault. Accordingly, a method may start from the top or the bottom and proceed where action on one finite element alters an adjacent (shared corner or shared boundary) finite element. Such action may simplify actions for the adjacent finite element. Thus, such a method can be synergistic for a region where a fault traverses multiple vertical columns of elements.

In the scenario 910, the fault traverses two columns of elements while in the scenario 930, the fault traverses three columns. As mentioned, for a basin model, a “horizontal” element size may be on the order of about 1 to about 100 meters. Thus, three columns may span about 3 meters to about 300 meters, which may provide some perspective (e.g., an estimate) as to how many columns a fault may traverse (e.g., as a function of finite element size). In general, as finite element size decreases, the number of columns a fault may traverse can be expected to increase. However, as size decreases, finite element dimension may approach that of a fault, which can act to increase accuracy. Whether large finite elements or small finite elements are employed to model a basin, a method that identifies elements with respect to a fault and adjusts the identified elements (e.g., by subdivision and node movement or node movement alone) can apply to diminish errors.

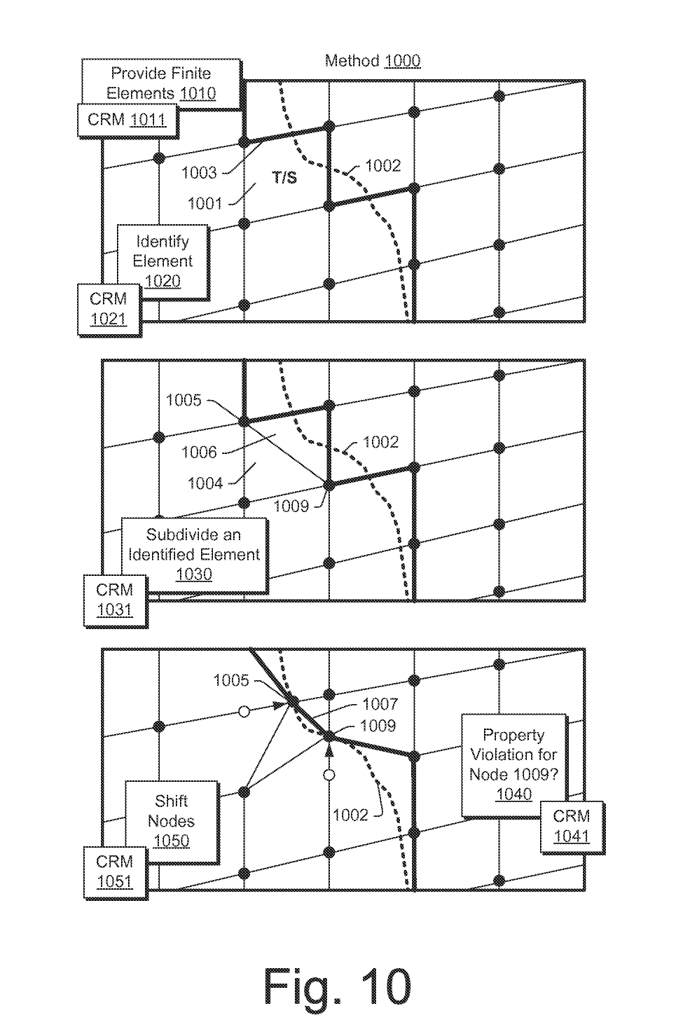

FIG. 10 shows a method 1000 that allows for certain mixed node movements, which may be conditional (e.g., based on facies, horizon, etc.). In the example of FIG. 10, the method 1000 includes a provision block 1010 to provide finite elements and an identification block 1020 to identify an element 1001 as having a fault passing through its top boundary and a side boundary where a model fault line 1003 passing along the top boundary and the side boundary to form a step (e.g., an inclined step). In a subdivision block 1030, the identified element 1001 is subdivided to form two elements 1004 and 1006 that share a common diagonal boundary that passes between shared nodes 1005 and 1009. In an optional violation block 1040, a check may occur as to whether movement of a node or nodes (e.g., shifting) would act to violate a property condition as to a finite element. In a movement or shift block 1050, the node 1005 is moved along a top boundary and the node 1009 is moved along a side boundary to thereby define an adjusted model fault line 1007 to more accurately represent the fault 1002. Where the violation block 1040 is implemented, such a move or shift may be contingent on whether a property condition would be violated (e.g., facies type violation, permeability violation, etc.).

In the example of FIG. 10, as mentioned, movement of a node may be conditional, for example, based on whether such movement would extend the boundary of a finite element into a region that has one or more different properties. A test may be applied to a prospective move by comparing one or more properties or a hash of properties, which would indicate that at least one property value differs. For example, given properties A, B and C, a comparison may be made of a sum of values (A+B+C) for a finite element to a sum of values for a neighboring element. In such an example, if the hash (e.g., sum) differs, then the movement may be prohibited (e.g., avoided). Use of a hash can reduce computation demands as a one-to-one comparison may not be required for each individual property value. A hash may optionally be defined based on properties that would likely be affected by movement of a node (e.g., as related to equations formulated that use the finite element) and may optionally include one or more weights to weight, normalize, etc., a property value.

The method 1000 is shown in FIG. 10 in association with various computer-readable media (CRM) blocks 1011, 1021, 1031, 1041 and 1051. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1000.

An example embodiment may include one or more computer-readable media comprising computer-executable instructions to instruct a computing device or computing system to: provide finite elements described with respect to a horizontal coordinate axis and a vertical coordinate axis to model a sedimentary basin; identify intersection points of a fault with respect to boundaries of the finite elements; for each identified intersection point, determine if shifting a node of a corresponding boundary to the intersection point violates one or more properties of a finite element; and to shift a node of a corresponding boundary to the intersection point where a violation of the one or more properties of the finite element does not occur.

In such an example, instructions may be provided to calculate a property hash value for at least some of the finite elements. For example, to calculate a property hash value for finite elements within a number of columns from the fault. In an example embodiment, instructions may be provided to select the one or more properties, for example, where the properties affect migration of fluid.

In an example embodiment, a method can include providing a model fault line where, in an identification block, intersection points are identified for a fault with respect to horizontal grid lines (e.g., “horizontal” boundary lines for finite elements), in a shift block, for each intersection point identified, a shift occurs for the next horizontal grid node to the intersection point (e.g., along the horizontal direction). Such a method may terminate after application of the shift block or it may proceed to a diagonalization block that diagonalizes elements (e.g., subdivides elements).

In an embodiment, when a fault is deemed “too horizontal,” the foregoing method can optionally either move one or more nodes vertically or project a fault to a nearest horizontal grid line.

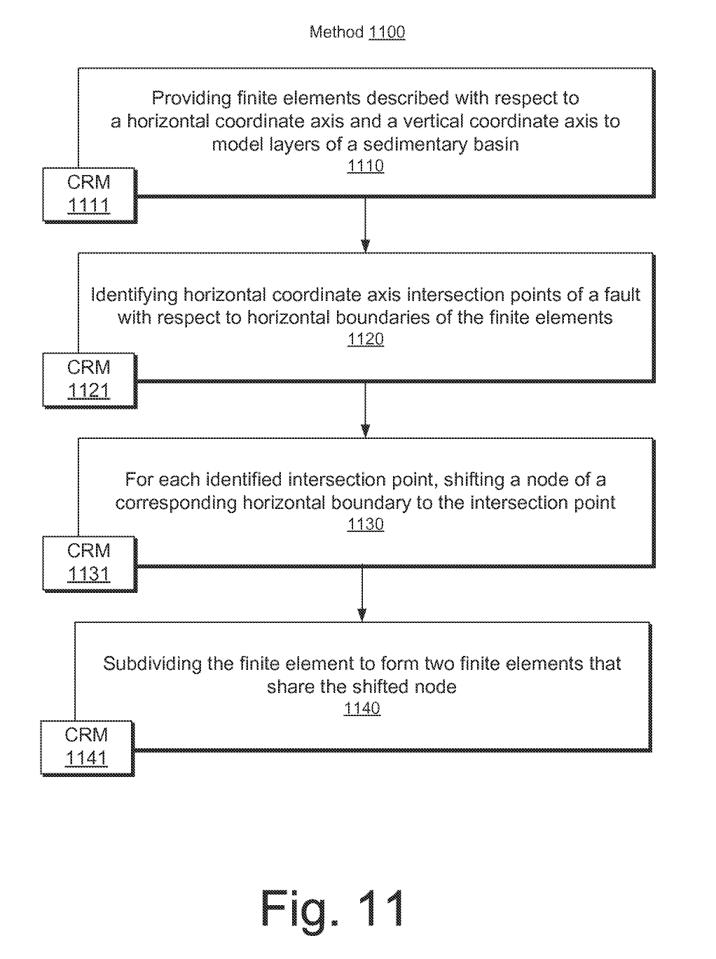

FIG. 11 shows an example of a method 1100 for adjusting finite elements. The method includes a provision block 1110 for providing finite elements described with respect to a horizontal coordinate axis and a vertical coordinate axis to model a sedimentary basin (e.g., defined with respect to horizons or layers); an identification block 1120 for identifying horizontal coordinate axis intersection points of a fault with respect to horizontal boundaries of the finite elements; and a shift block 1130, where for each identified intersection point, shifting occurs for a node of a corresponding horizontal boundary to the intersection point. As shown, the method 1100 can include a subdivision block 1140 for subdividing a finite element to form two finite elements that share a shifted node. In such a method, when a fault is deemed “too horizontal” (e.g., flat), the method may optionally move one or more nodes vertically or project a fault to a nearest horizontal grid line. For example, the method may optionally identify a vertical coordinate axis intersection point (or points) and shift a node (or nodes) vertically to the intersection point (or points).

In an example embodiment, a method can include simulating physical phenomena in a sedimentary basin with respect to time, for example, such as simulating migration of fluid in the sedimentary basin. In such an example, simulating migration of fluid can include simulating migration of fluid adjacent to the fault.

In an example embodiment, a method can include repeating an identification process for another, different fault. Such a method can proceed until any number of faults has been accounted for.

In an example embodiment, finite elements are two-dimensional spatial finite elements or three-dimensional spatial finite elements. A method may include modeling evolution of a sedimentary basin using finite elements with a finite element technique for spatial modeling and a finite difference discretization of time with a finite difference technique for temporal modeling.

In an example embodiment, finite elements can include properties where each finite element includes property values based at least in part on measured values (e.g., measured for an actual basin).

The method 1100 is shown in FIG. 11 in association with various computer-readable media (CRM) blocks 1111, 1121, 1131 and 1141. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1100.

As an example, one or more computer-readable media can include computer-executable instructions to instruct a computing device to: provide finite elements described with respect to a horizontal coordinate axis and a vertical coordinate axis to model a sedimentary basin (see, e.g., CRM 1111); identify a horizontal coordinate axis intersection point of a fault with respect to a boundary of one of the finite elements (see, e.g., CRM 1121); and shift a finite element node, that defines the boundary, to the intersection point (see, e.g., CRM 1131). In an example embodiment, instructions such as those of CRM 1141 may follow, for example, to instruct a computing device to subdivide the finite element to form two finite elements.

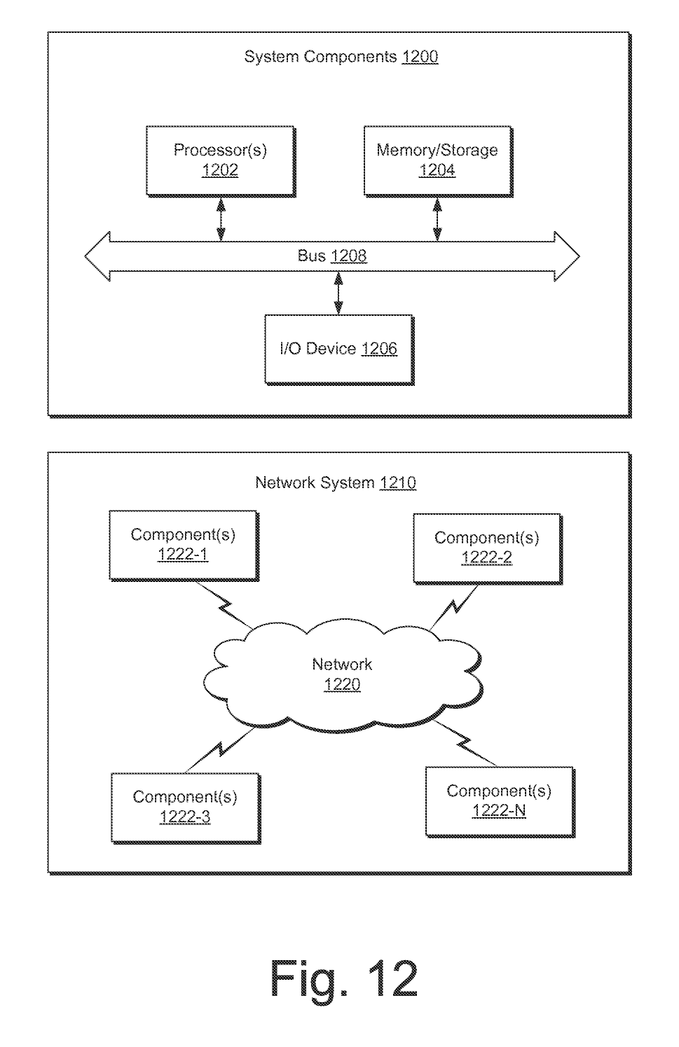

FIG. 12 shows components of an example of a computing system 1200 and an example of a networked system 1210. The system 1200 includes one or more processors 1202, memory and/or storage components 1204, one or more input and/or output devices 1206 and a bus 1208. In an example embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). In an example embodiment, a computer-readable medium may be a storage component such as a physical memory storage device, for example, a chip, a chip on a package, a memory card, etc.

In an example embodiment, components may be distributed, such as in the network system 1210. The network system 1210 includes components 1222-1, 1222-2, 1222-3, . . . 1222-N. For example, the components 1222-1 may include the processor(s) 1202 while the component(s) 1222-3 may include memory accessible by the processor(s) 1202. Further, the component(s) 1202-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. A method comprising:
providing finite elements described with respect to a horizontal coordinate axis and a vertical coordinate axis to model a sedimentary basin;
identifying a finite element having a horizontal boundary intersected by a fault;
subdividing the finite element into two finite elements; and
representing the fault along a boundary between the two finite elements.

2. The method of claim 1 wherein the identifying comprises identifying a horizontal coordinate axis intersection point of the fault with respect to the horizontal boundary of the finite element; and further comprising shifting a shared node of the two finite elements to the intersection point.

3. The method of claim 1 further comprising simulating physical phenomena in the sedimentary basin with respect to time.

4. The method of claim 1 further comprising simulating migration of fluid in the sedimentary basin.

5. The method of claim 4 wherein the simulating migration of fluid comprises simulating migration of fluid adjacent to the fault.

6. The method of claim 1 further comprising repeating the identifying for another, different fault.

7. The method of claim 1 wherein the finite elements comprise two-dimensional spatial finite elements.

8. The method of claim 1 wherein the finite elements comprise three-dimensional spatial finite elements.

9. The method of claim 1 further comprising modeling evolution of the sedimentary basin using the finite elements with a finite element technique for spatial modeling and a finite difference discretization of time with a finite difference technique for temporal modeling.

10. The method of claim 1 wherein the sedimentary basin comprises layers defined by horizons.

11. The method of claim 1 wherein the finite elements comprise properties and each finite element comprises property values based at least in part on measured values.

12. One or more computer-readable media comprising computer-executable instructions to instruct a computing device to:
provide finite elements described with respect to a horizontal coordinate axis and a vertical coordinate axis to model a sedimentary basin;
identify a horizontal coordinate axis intersection point of a fault with respect to a boundary of one of the finite elements; and
shift a finite element node, that defines the boundary, to the intersection point.

13. The one or more computer-readable media of claim 12 further comprising instructions to instruct a computing device to subdivide the finite element to form two finite elements wherein the two finite elements share the shifted finite element node.

14. The one or more computer-readable media of claim 12 wherein the instructions to instruct a computing device to identify comprise instructions to identify another horizontal coordinate axis intersection point of the fault with respect to another boundary of the one of the finite elements and wherein the instructions to instruct a computing device to shift comprise instructions to shift another finite element node, that defines the other boundary, to the other intersection point.

15. The one or more computer-readable media of claim 12 further comprising instructions to instruct a computing device to simulate the sedimentary basin using the finite elements wherein the finite elements comprise finite elements that share the shifted finite element node.

16. One or more computer-readable media comprising computer-executable instructions to instruct a computing device to:
provide finite elements described with respect to a horizontal coordinate axis and a vertical coordinate axis to model a sedimentary basin;
identify intersection points of a fault with respect to boundaries of the finite elements;
for each identified intersection point, determine if shifting a node of a corresponding boundary to the intersection point violates one or more properties of a finite element; and
shift a node of a corresponding boundary to the intersection point where a violation of the one or more properties of the finite element does not occur.

17. The one or more computer-readable media of claim 16 further comprising instructions to instruct a computing device to calculate a property hash value for at least some of the finite elements.

18. The one or more computer-readable media of claim 17 wherein the instructions comprise instructions to instruct a computing device to calculate a property hash value for finite elements within a number of columns from the fault.

19. The one or more computer-readable media of claim 16 further comprising instructions to instruct a computing device to select the one or more properties.

20. The one or more computer-readable media of claim 19 wherein the properties affect migration of fluid.
